(19) United States
(12) Patent Application Publication
(10) Pub. No.: US 2025/0065160 A1
(43) Pub. Date: Feb. 27, 2025

(54) JOIST ANCHOR

(71) Applicant: WERNER CO., ITASCA, IL (US)

(72) Inventors: Eric Patrick, Manor, TX (US); Glenn Hartop, Austin, TX (US); Daniel Aleksovski, Signal Mountain, TN (US)

(73) Assignee: WERNER CO., ITASCA, IL (US)

(21) Appl. No.: 18/813,385

(22) Filed: Aug. 23, 2024

Related U.S. Application Data
(60) Provisional application No. 63/534,667, filed on Aug. 25, 2023.

(51) Int. Cl. A62B 35/00

(52) U.S. Cl. CPC A62B 35/0068; A62B 35/005

(57) ABSTRACT

A joist anchor including a ring having a ring portion formed as an enclosed ring and an attachment portion, a swivel mechanism disposed at a first side of the joist girder and attached to the attachment portion of the ring at an attachment point, wherein the swivel mechanism is structured to permit the ring to swivel about a central axis of the swivel mechanism and to pivot about the attachment point, a U-channel having a planar horizontal portion and two planar vertical portions extending from opposite ends of the planar horizontal portion, wherein the planar horizontal portion is structured to directly abut against a second side of the joist girder opposite the first side of the joist girder, and a bolt structured to extend through the swivel mechanism, a gap between the left and right members of the joist girder, and the U-channel.

### CROSS REFERENCE TO RELATED APPLICATIONS

This application claims priority to U.S. Patent Application Ser. No. 63/534,667, filed Aug. 25, 2023, entitled, Joist Anchor, which is incorporate herein by reference in its entirety.

### FIELD OF THE INVENTION

The disclosed concept relates generally to anchors for fall protection systems, and more particularly, to anchors for use with joist girders.

### BACKGROUND OF THE INVENTION

Fall protection systems typically require anchor points attached to a structure. A user may then attach a lanyard to the anchor point. However, anchor points often require drilling into the structure to securely attach an anchoring device to the structure, or modifying the structure in some manner to accommodate attachment of an anchoring device or to create an anchor point from the structure. Drilling into or modifying the structure can be detrimental to the structure.

One type of structure is a joist girder. A joist girder is a structural element in a facility, and as such, it can be particularly detrimental to drill into or modify a joist girder. However, joist girders are often disposed in locations that would serve well for anchor points for fall protection systems. It is a challenge to create an anchor point with sufficient strength for use in fall protection applications without drilling into or otherwise modifying the structure it is attached to.

### SUMMARY OF THE INVENTION

In accordance with an aspect of the disclosed concept, a joist anchor for a joist girder having left and right members comprises: a ring having a ring portion formed as an enclosed ring and an attachment portion; a swivel mechanism disposed at a first side of the joist girder and attached to the attachment portion of the ring at an attachment point, wherein the swivel mechanism is structured to permit the ring to swivel about a central axis of the swivel mechanism and to pivot about the attachment point; a U-channel having a planar horizontal portion and two planar vertical portions extending from opposite ends of the planar horizontal portion, wherein the planar horizontal portion is structured to directly abut against a second side of the joist girder opposite the first side of the joist girder; and a bolt structured to extend through the swivel mechanism, a gap between the left and right members of the joist girder, and the U-channel.

In accordance with an aspect of the disclosed concept, a joist anchor for a joist girder having left and right members comprises: a ring having a ring portion formed as an enclosed ring and an attachment portion; a swivel mechanism disposed at a first side of the joist girder and attached to the attachment portion of the ring at an attachment point, wherein the swivel mechanism is structured to permit the ring to swivel about a central axis of the swivel mechanism and to pivot about the attachment point; a plate load spreader structured to be disposed between the swivel mechanism and the first side of the joist girder and directly abut against both the swivel mechanism and the first side of the joist girder; a U-channel structured to directly abut against a second side of the joist girder opposite the first side of the joist girder; and a fastening mechanism structured to attach the joist anchor to the joist girder.

In accordance with an aspect of the disclosed concept, a joist anchor for a joist girder having left and right members comprises: a ring having a ring portion formed as an enclosed ring and an attachment portion; a swivel mechanism disposed at a first side of the joist girder and attached to the attachment portion of the ring at an attachment point, wherein the swivel mechanism is structured to permit the ring to swivel about a central axis of the swivel mechanism and to pivot about the attachment point; and a fastening mechanism structured to attach the joist anchor to the joist girder.

### BRIEF DESCRIPTION OF THE DRAWINGS

A full understanding of the invention can be gained from the following description of the preferred embodiments when read in conjunction with the accompanying drawings in which:

FIG. 1 is a view of a joist anchor in accordance with an example embodiment of the disclosed concept attached to a joist girder;

FIG. 2 is another view of a joist anchor in accordance with an example embodiment of the disclosed concept attached to a joist girder;

FIG. 3 is an isometric view of a joist anchor in accordance with an example embodiment of the disclosed concept;

FIG. 4 is a side view of the joist anchor of FIG. 3;

FIG. 5 is a front view of the joist anchor of FIG. 3; and

FIG. 6 is a top view of the joist anchor of FIG. 3.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

In accordance with aspects of the disclosed concept, a joist anchor 10 creates an anchor point on a joist girder 1 by compressing against the top and bottom (i.e. opposite sides) of the joist girder 1. The joist anchor 10 may be used as a permanent or temporary anchor point on the joist girder 1. The joist anchor 10 provides sufficient strength to be used as an anchor point in a fall protection system.

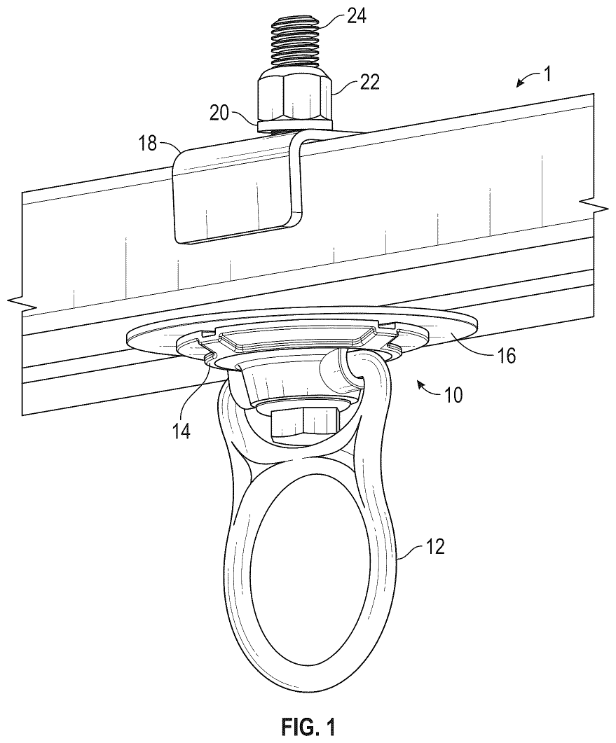

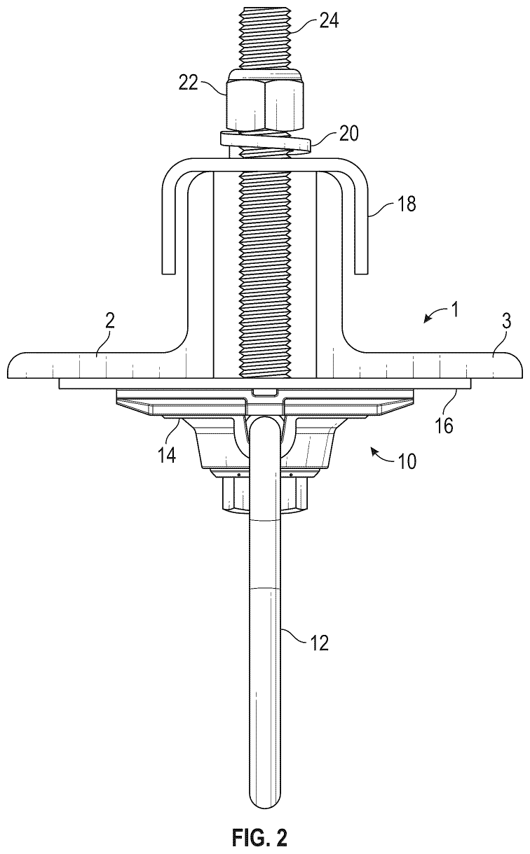

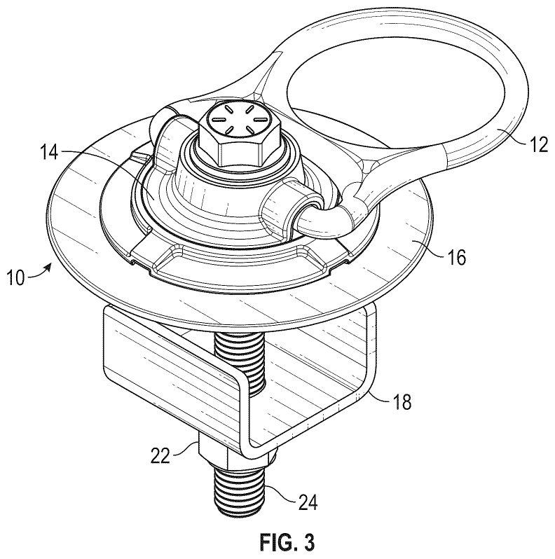

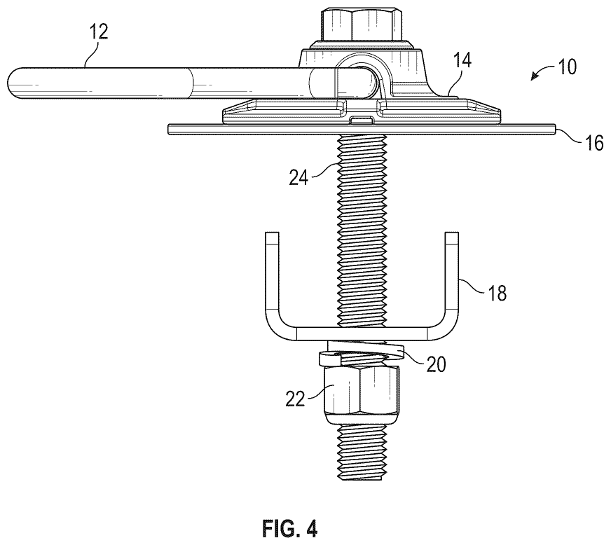

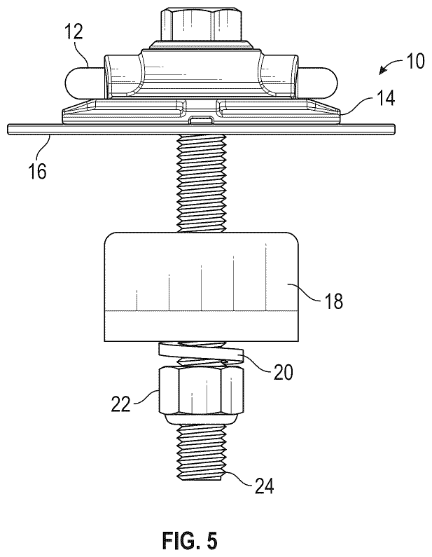

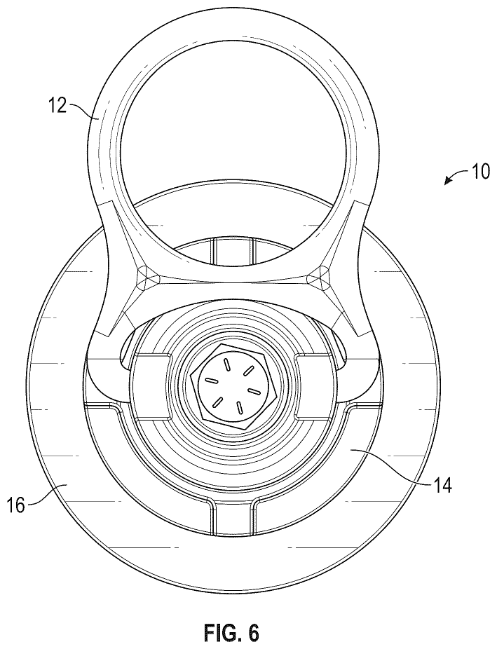

FIGS. 1 and 2 are views of a joist anchor 10 in accordance with an example embodiment of the disclosed concept attached to a joist girder 1. FIG. 3 is an isometric view of the joist anchor 10 in accordance with an example embodiment of the disclosed concept. FIGS. 4, 5, and 6 are side, front, and top views, respectively of the joint anchor 10.

The joist anchor 10 includes a ring 12, a swivel mechanism 14, a plate load spreader 16, a U-channel 18, a washer 20, a nut 22, and a bolt 24. The ring 12 is attached to the swivel mechanism 14. The ring 12 includes a ring portion formed as an enclosed ring and an attachment portion. The ring portion is structured to allow a carabiner or the like to be attached to the ring 12. The attachment portion includes two portions which are structured to extend into and thus attach the ring to the swivel mechanism 14.

The swivel mechanism 14 is structured to permit the ring 12 to swivel about the central axis of the swivel mechanism 14 as well as to pivot about its attachment point to the swivel mechanism 14. Thus, the ring 12 may swivel and pivot without detaching from the swivel mechanism 14. In some example embodiments, the ring 12 may swivel in a 360° range and may pivot in a 180° range. The swiveling and pivoting of the ring 12 may be caused by pulling of a carabiner or similar device attached to the ring 12. For example, a worker may attach their lifeline to the ring 12 via a carabiner or similar device, and as the worker moves about, the ring 12 will swivel and pivot correspondingly based on the forces applied to the ring 12 through the lifeline and carabiner. The swiveling and pivoting of the ring 12 allow the ring 12 to be more optimally oriented toward the worker. For example, in the case of a fall, forces applied to the ring 12 would be applied primarily through a centerline of the ring 12 as opposed to off-center. Applying forces along the centerline of the ring 12 allows the forces to be distributed evenly among the two points where the ring 12 attaches to the swivel mechanism 14, thus allowing the joist anchor 10 to handle higher forces compared to anchor points that do not provide such swiveling and pivoting. As an example, an off-center force can apply a greater force to one side of an anchor point and cause that side to fail at lower forces than if the force was applied along its centerline and evenly distributed between the sides of the anchor point. In some example embodiments, a swivel mechanism such as that described in U.S. Pat. No. 8,424,638, which is incorporated in its entirety herein by reference, may be employed. However, it will be appreciated that other swivel mechanisms that provide for swiveling and pivoting of the ring 12 may be employed without departing from the scope of the disclosed concept.

The plate load spreader 16 is a planar member whose upper side abuts directly against a lower side of the swivel mechanism 14 and whose lower side abuts directly against the joist girder 1. The joist girder 1 includes a left member 2 and a right member 3 spaced apart from the left member 2 forming a gap between the left member 2 and the right member 3. The plate load spreader 16 spans the gap such that a portion of the plate load spreader 16 abuts against the left member, a portion of the plate load spreader 16 spans across the gap, and a portion of the plate load spreader 16 abuts against the right member 3. In the example embodiment shown, the plate load spreader 16 has a circular shape. However, it will appreciated that the plate load spreader 16 may have different shapes without departing from the scope of the disclosed concept.

The left member 2 and the right member 3 of the joist girder 1 are each L-shaped with a vertical portion and a horizontal portion. The left member 2 and the right member 3 are arranged such that the horizontal portions extend away from each other and the vertical portions extend in parallel with each other. The plate load spreader 16 is structured to abut against the horizontal portions of the left and right members 2,3 of the joist girder 1. The U-channel 18 is U-shaped having a planar horizonal portion and two planar vertical portions. The U-channel 18 is structured such that the horizontal portion abuts against an end of the vertical portions of the left and right members 2,3 of the joist girder 1 and the vertical portions of the U-channel 18 extend along an outside portion of the height of the vertical portions of the left and right members 2,3 of the joist girder 1. In some example embodiments, the U-channel 18 is a unitary piece. That is, the U-channel 18 is a single piece of material, such as metal, and has no joints. In some example embodiments, the U-channel 18 may be formed by bending a single piece of sheet metal into a U-shape.

The bolt 24 extends through the swivel mechanism 14, the plate load spreader 16, the gap between the left and right members 2,3 of the joist girder 1, and the U-channel 18. The swivel mechanism 14, the plate load spreader 16, and the U-channel 18 each include apertures through which the bolt 24 may extend. The apertures are sized large enough that a threaded portion of the bolt 24 may extend through them, but small enough that a head of the bolt 24 may not extend through them. In some example embodiments, the head of the bolt 24 may be disposed at the swivel mechanism 14. The washer 20 is disposed between the U-channel 18 and the nut 22. The nut 22 corresponds to the bolt 24 such that the nut 22 may be threaded onto the bolt 24.

The joist anchor 10 is structured such that when attached to the joist girder 1, the swivel mechanism 14 directly abuts the plate load spreader 16 and the plate load spreader 16 directly abuts the horizontal portions of the left and right members 2,3 of the joist girder 1. The U-channel 18 directly abuts the vertical portions of the left and right members 2,3 of the joist girder 1 on an opposite side of the joist girder 1 as the plate load spreader 16. The bolt 24 extends from the swivel mechanism 14 and plate load spreader 16 through the gap in the joist girder 1 and through the U-channel 18. One side of the horizontal portion of the U-channel 18 directly abuts the joist girder 1 and the opposite side of the horizontal portion of the U-channel 18 directly abuts the washer 20. The nut 22 is threaded onto the bolt 24 such that it directly abuts the washer 20 and sandwiches the washer 20 between the nut 22 and the U-channel 18. In this manner, the plate load spreader 16 is tightly secured against one side of the joist girder 1 and the U-channel 18 is tightly secured against an opposite side of the joist girder 1, thus compressing the joist anchor 10 against the top and bottom of the joist girder 1 and tightly securing the joist anchor 10 to the joist girder 1. In some example embodiments, the washer 20, the nut 22, and the bolt 24 may be considered a fastening mechanism for attaching the joist anchor 10 to the joist girder 1. In some example embodiments, the U-channel 18 may also be considered as part of the fastening mechanism.

In some example embodiments of the disclosed concept, the joist anchor 10 is structured to have a static strength of at least 5000 lbs. That is, a weight of at least 5000 lbs. may be attached to the ring 12 before the joist anchor 10 fails, such as detaching or breaking.

In some example embodiments, the washer 20 may be composed of steel. However, it will be appreciated that in some example embodiments, other materials may be employed in the washer 20. In some example embodiments, the washer 20 may be a split lock washer. However, it will be appreciated that in some other example embodiments, other types of washers may be employed. In some example embodiments, the nut 22 may be nylon lock nut. It will be appreciated that in some other example embodiments, other types of nuts may be employed. A nylon lock nut and/or a split lock washer assist with reducing vibration and loosening of the bolt 24. In some example embodiments, the bolt 24 is composed of zinc. However, it will be appreciated that other materials may be employed in the bolt 24 without departing from the scope of the disclosed concept.

In accordance with example embodiments of the disclosed concept, the joist anchor 10 permits temporary or permanent attachment to a joist girder 1, without drilling into or modifying the joist girder 1, and with sufficient strength to create an anchor point for use in fall protection systems.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A joist anchor for a joist girder having left and right members, the joist anchor comprising:
a ring having a ring portion formed as an enclosed ring and an attachment portion;
a swivel mechanism disposed at a first side of the joist girder and attached to the attachment portion of the ring at an attachment point, wherein the swivel mechanism is structured to permit the ring to swivel about a central axis of the swivel mechanism and to pivot about the attachment point;
a U-channel having a planar horizontal portion and two planar vertical portions extending from opposite ends of the planar horizontal portion, wherein the planar horizontal portion is structured to directly abut against a second side of the joist girder opposite the first side of the joist girder; and
a bolt structured to extend through the swivel mechanism, a gap between the left and right members of the joist girder, and the U-channel.

2. The joist anchor of claim 1, wherein the swivel mechanism is structured to permit the ring to swivel in a range of 360° about the central axis of the swivel mechanism and to pivot in a range of 180° about the attachment point.

3. The joist anchor of claim 1, further comprising:
a plate load spreader structured to be disposed between the swivel mechanism and the first side of the joist girder and directly abut against both the swivel mechanism and the first side of the joist girder,
wherein the bolt is structured to extend through the swivel mechanism, the plate spreader, the gap between the left and right members of the joist girder, and the U-channel.

4. The joist anchor of claim 3, wherein the plate load spreader is structured to span the gap between the left and right members of the joist girder, and
wherein a first portion of the plate load spreader is structured to abut against the left member of the joist girder and a second portion of the plate load spreader is structured to abut against the right member of the joist girder.

5. The joist anchor of claim 3, wherein the plate load spreader has a circular shape.

6. The joist anchor of claim 1, further comprising:
a nut structured to receive the bolt and secure the joist anchor to the joist girder.

7. The joist anchor of claim 6, wherein the nut is a nylon lock nut.

8. The joist anchor of claim 6, further comprising:
a washer structured to receive the bolt and directly abut against the U-channel,
wherein the nut is structured to directly abut against the washer to secure the joist anchor to the joist girder.

9. The joist anchor of claim 8, wherein the washer is a split lock washer.

10. The joist anchor of claim 1, wherein the joist anchor has a static strength of at least 5000 lbs.

11. A joist anchor for a joist girder having left and right members, the joist anchor comprising:
a ring having a ring portion formed as an enclosed ring and an attachment portion;
a swivel mechanism disposed at a first side of the joist girder and attached to the attachment portion of the ring at an attachment point, wherein the swivel mechanism is structured to permit the ring to swivel about a central axis of the swivel mechanism and to pivot about the attachment point;
a plate load spreader structured to be disposed between the swivel mechanism and the first side of the joist girder and directly abut against both the swivel mechanism and the first side of the joist girder;
a U-channel structured to directly abut against a second side of the joist girder opposite the first side of the joist girder; and
a fastening mechanism structured to attach the joist anchor to the joist girder.

12. The joist anchor of claim 11, wherein the fastening mechanism includes:
a bolt structured to extend through the swivel mechanism, a gap between the left and right members of the joist girder, the plate load spreader, and the U-channel; and
a nut structured to receive the bolt and attach the joist anchor to the joist girder.

13. The joist anchor of claim 12, wherein the fastening mechanism includes:
a washer structured to receive the bolt and directly abut against the U-channel,
wherein the nut is structured to directly abut against the washer to attach the joist anchor to the joist girder.

14. The joist anchor of claim 11, wherein the left and right members of the joist girder are each L-shaped with a vertical portion and a horizontal portion, wherein the horizontal portions are disposed at the first side of the joist girder and extend away from each other, and wherein the vertical portions extend in parallel with each other from the first side to the second side of the joist girder to form a gap between the left and right members of the joist girder.

15. The joist anchor of claim 14, wherein the plate load spreader is structured to directly abut against the horizontal portions of the left and right members of the joist girder.

16. The joist anchor of claim 14, wherein the U-channel includes a planar horizontal portion and two planar vertical portions extending from opposite ends of the planar horizontal portion, wherein the planar horizontal portion of the U-channel is structured to abut against the second side of the joist girder, and wherein the planar vertical portions of the U-channel are structured to extend along outside portions of the heights of the vertical portions of the left and right members of the joist girder.

17. The joist anchor of claim 11, wherein the joist anchor has a static strength of at least 5000 lbs.

18. A joist anchor for a joist girder having left and right members, the joist anchor comprising:
a ring having a ring portion formed as an enclosed ring and an attachment portion;
a swivel mechanism disposed at a first side of the joist girder and attached to the attachment portion of the ring at an attachment point, wherein the swivel mechanism is structured to permit the ring to swivel about a central axis of the swivel mechanism and to pivot about the attachment point; and
a fastening mechanism structured to attach the joist anchor to the joist girder.

19. The joist anchor of claim 18, wherein the fastening mechanism includes:
a U-channel structured to directly abut against a second side of the joist girder opposite the first side of the joist girder;
a bolt structured to extend through the swivel mechanism, a gap between the left and right members of the joist girder, and the U-channel;
a nut structured to receive the bolt; and
a washer structured to receive the bolt and directly abut against the U-channel,
wherein the nut is structured to directly abut against the washer to attach the joist anchor to the joist girder.

20. The joist anchor of claim 18, wherein the swivel mechanism is structured to permit the ring to swivel in a range of 360° about the central axis of the swivel mechanism and to pivot in a range of 180° about the attachment point.
